(19) United States
(12) Patent Application Publication
(10) Pub. No.: US 2025/0053546 A1
(43) Pub. Date: Feb. 13, 2025

(54) DATA STRUCTURE FOR ORPHAN TRANSACTIONS

(71) Applicant: nChain Licensing AG, Zug (CH)

(72) Inventors: Alexandru PAUNOIU, London (GB); Enrique LARRAIA, London (GB)

(21) Appl. No.: 18/717,986

(22) PCT Filed: Nov. 7, 2022
(86) PCT No.: PCT/EP2022/080934

§ 371 Date: Jun. 7, 2024

(30) Foreign Application Priority Data
Dec. 7, 2021 (GB) 2117623.5

(51) Int. Cl. G06F 16/21; G06F 9/46

(52) U.S. Cl. CPC G06F 16/211; G06F 9/466

(57) ABSTRACT

A computer-implemented method performed by a blockchain node and comprising: maintaining a data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of blockchain node, and wherein: the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node.

### CROSS REFERENCE TO RELATED APPLICATIONS

This application is the U.S. National Stage of International Application No. PCT/EP2022/080934, filed on Nov. 7, 2022, which claims the benefit of United Kingdom Patent Application No. 2117623.5, filed on Dec. 7, 2021, the contents of which are incorporated herein by reference in their entireties.

### TECHNICAL FIELD

The present disclosure relates to a method of creating and/or maintaining a data structure for representing orphan transactions, and to the data structure itself.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

### SUMMARY

Blockchain transactions form a chain, whereby an input of one transaction (a child transaction) references an output of a previous transaction (a parent transaction) in the chain. The chain can contain any number of transactions.

Before a child transaction can be included in a block it must be validated by a blockchain node. The process of validating a child transaction includes performing various checks on and/or using the parent transaction, e.g. verifying that the parent transaction exists, verifying that the amount of digital asset distributed across the outputs of the child transaction is not greater than the amount of digital asset associated with the referenced output of the parent transaction, etc.

However, the blockchain node may not necessarily receive the chain of transactions in order. For example, the child transaction may arrive at the node before the parent arrives, or even before the grandparent arrives. Such transactions are known as orphan transactions. Since the blockchain node requires the parent transaction to validate a child transaction, the child transaction cannot be validated.

Some blockchain protocols use a validation pipeline to process and validate transactions. The validation pipeline comprises a series of processors, each performing a particular task. At least one processor is tasked with validating the child transaction based on the parent transaction. An identified bottleneck for validating transactions occurs when a child transaction enters the validation pipeline and one of its outpoints (i.e. an output of a previous transaction referenced by an input of the child transaction) belongs to a parent transaction that has not yet been seen by the blockchain node. This leads to a deadlock problem where the blockchain node repeatedly tries and fails to validate the child transaction, and prioritises validation of the child transaction over the parent transaction.

According to one aspect disclosed herein, there is provided a computer-implemented method performed by a blockchain node and comprising: maintaining a data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of the blockchain node, and wherein: the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and wherein each node of the graph is associated with a respective transaction identifier of the respective transaction represented by that node and comprises:
a) a respective indegree value, wherein the respective indegree value is one of: i) a first value indicating that the respective transaction has an unknown number of parent transactions that are either unavailable transactions or orphan transactions, or ii) a zero value indicating that the respective transaction has no parent transactions that are either unavailable transactions or orphan transactions, or iii) a value indicating the number of respective parent transactions of the respective transaction that are either unavailable transactions or orphan transactions; and b) a list of respective references of respective child nodes, if any, that are connected to that node by respective edges.

According to another aspect disclosed herein, there is provided a data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of a blockchain node, and wherein: the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and wherein each node of the graph is associated with a respective transaction identifier of the respective transaction represented by that node and comprises: a) a respective indegree value, wherein the respective indegree value is one of: i) a first value indicating that the respective transaction has an unknown number of parent transactions that are either unavailable transactions or orphan transactions, or ii) a zero value indicating that the respective transaction has no parent transactions that are either unavailable transactions or orphan transactions, or iii) a value indicating the number of respective parent transactions of the respective transaction that are either unavailable transactions or orphan transactions; and b) a list of respective references of respective child nodes, if any, that are connected to that node by respective edges.

The present disclosure provides a novel data structure (referred to as an “orphan pool”) for representing and/or organising orphan transactions. The orphan pool is updated by adding or updating nodes when orphan transactions arrive at the blockchain node. Orphan transactions are sent to the orphan pool rather than to the validation pipeline, thus avoiding the deadlock problem. Similarly, the orphan pool is updated as orphan transactions are released from the orphan pool to the node's validation pipeline when the necessary parent transactions become available. The data structure utilises a directed graph of nodes and edges. Here “node” is used in a different context to refer to an element of the graph, and not the blockchain node that creates and/or maintains the graph.

Each node in the graph (“graph node”) represents a transaction in the orphan pool. More specifically, each graph node represents either an orphan transaction, or an unavailable transaction. An unavailable transaction (also referred to as an “unseen transaction”) is a transaction that has not been seen by the blockchain node's validation pipeline, or in some examples, by the blockchain node as a whole. An orphan transaction is a child transaction of an orphan transaction (i.e. the parent of the child transaction is an orphan transaction), or a child of an unseen transaction.

Each graph node may also comprise the transaction represented by that node. Alternatively, the transaction may be stored elsewhere and, in some embodiments, the location (e.g. memory address) of the transaction may be referenced by the graph node.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 is a schematic block diagram of an example blockchain node for having an orphan pool,

FIG. 5 schematically illustrates an example orphan pool structure,

FIG. 6 schematically illustrates a node being added (i) and a node being updated (ii) in an orphan pool, and

FIG. 7 schematically illustrates nodes being removed from the orphan pool.

### DETAILED DESCRIPTION OF EMBODIMENTS

### 1. Example System Overview

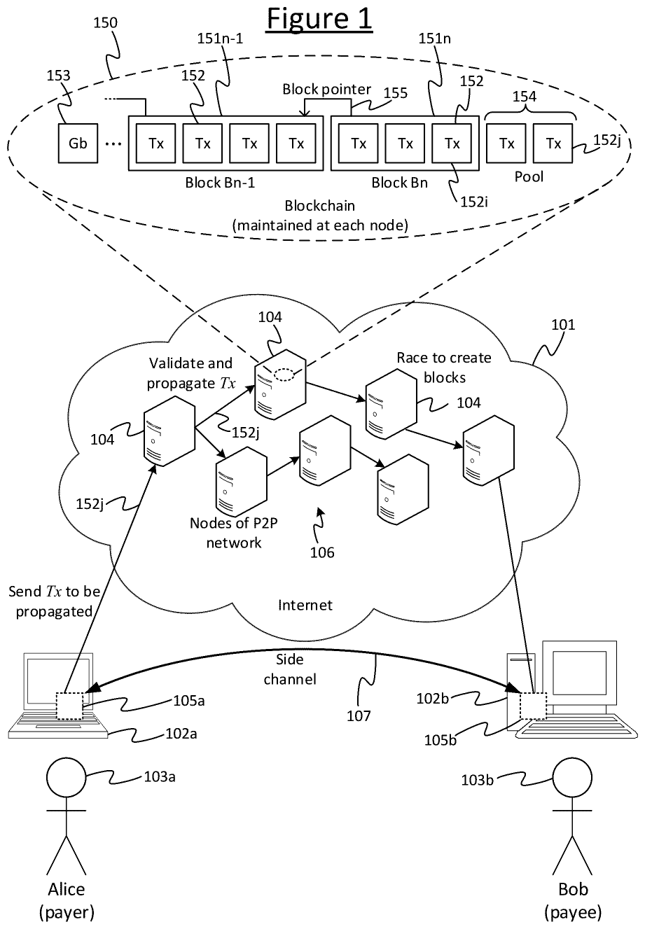

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

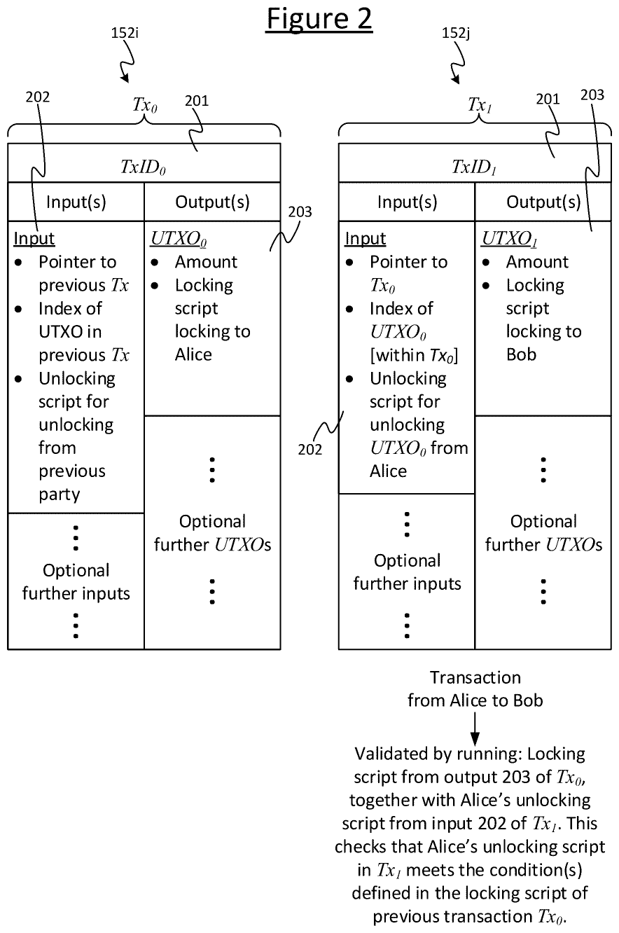

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} \text{><} {P}_{A} > \vert \vert [ Checksig {P}_{A} ]$$

where “| |” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Node Software

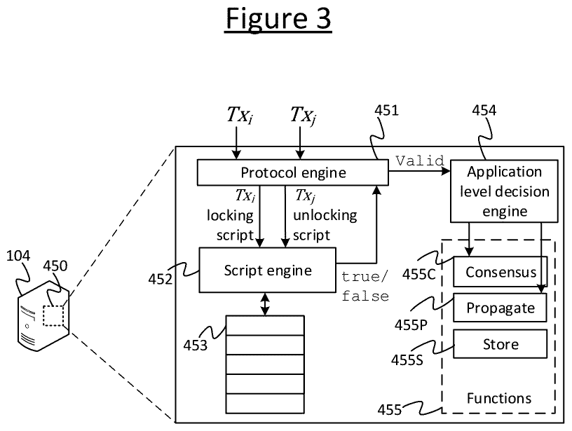

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 4. Orphan Pool

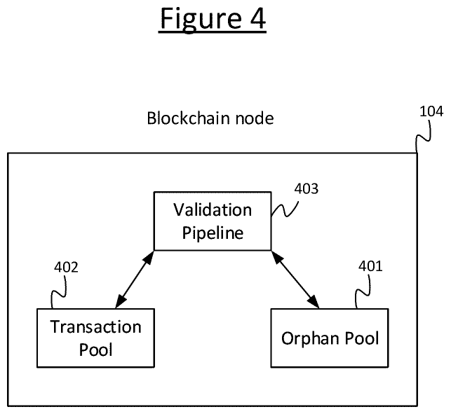

FIG. 4 schematically illustrates components of a blockchain node 104 configured to implement embodiments of the present disclosure. The blockchain node 104 comprises an orphan pool 401, a transaction pool 402 and a validation pipeline 403. It will be appreciated that the blockchain node 104 may comprises other components, e.g. those described with reference to FIG. 3, such as a protocol engine 451, script engine 452, etc. The blockchain node 104 is configured to receive and validate transactions, e.g. for the purposes of constructing a block of transactions and propagating valid transactions to other nodes 104 of the blockchain network 106. The blockchain node 104 may use the transaction pool 402 to store transactions that have been validated, either by the node 104 itself or by a different node 104. The transaction pool may take the form of the ordered pool 154 (or “mempool”) described above with reference to FIG. 1.

As mentioned earlier above, transactions form a chain, with each transaction other than the initial transaction (“coinbase transaction” or “generation transaction”) in the chain referring back to a previous transaction in the chain. A referenced transaction is known as a parent transaction, with the transaction that references the parent being known as the child transaction. A child transaction may have more than one parent transaction. To validate a child transaction, the validation pipeline 403 requires each of the parent transactions that are referenced by the child transaction. Without the parent transaction(s), the validation pipeline may repeatedly try and fail to validate the child transaction, thus causing a deadlock problem. A parent transaction may be unavailable to the validation pipeline 403 because it has not yet arrived at (i.e. been seen by) the blockchain node 104, or at least not at the validation pipeline 403. A transaction that has not been seen is referred to herein as an unavailable transaction, or unseen transaction. Both terms may be used interchangeably.

An orphan transaction is defined herein as a child transaction that references at least one unavailable transaction and/or at least one other orphan transaction. In other words, an orphan transaction is a child transaction that belongs to a chain of transactions wherein at least one transaction in the chain is an unavailable transaction.

The blockchain node 104 is configured to store orphan transactions in the orphan pool 401. Embodiments of the present disclosure provide a data structure that represents the orphan pool 401. The data structure can be efficiently updated to reflect and enable changes in the orphan pool 401, including the addition and release of orphan transactions to and from the orphan pool 401.

The data structure comprises a plurality of nodes and edges in the form of a directed acyclic graph. Nodes are connected by edges. Each node is connected to at least one other node by a respective edge. A node may be connected to multiple other nodes by respective nodes. Each node is a parent node, a child node, or both. Each node represents an unavailable transaction or an orphan transaction. The edges connecting nodes represent the referencing of one transaction by another. That is, an edge between a child node and a parent node is formed by, and represents, an input of the child transaction represented by the child node referencing (i.e. spending) an output of the parent transaction represented by the parent node.

The graph is used to represent the relationships between the orphan transactions and the unavailable transactions that the blockchain node 104 is aware of, e.g. the orphan transactions that have been sent to the blockchain node 104 and the unavailable transactions that are referenced by those orphan transactions.

Each node of the graph is associated with a transaction identifier of the transaction represented by that node. For instance, the node may comprise the transaction identifier. In other examples, the node may comprise a node identifier that is based on the transaction identifier, e.g. the node identifier may be a hash of the transaction identifier.

Each node of the graph comprises an indegree value. As is known in the art, the indegree value represents the number of edges directed into (i.e. towards) a node. In embodiments, the indegree value may be set as one of three types of values. The indegree value may be set as a first value (e.g. “undefined”) representing the number of edges directed into the node is undefined, indicating that the transaction represented by the node is an unavailable transaction. Since the transaction is unavailable, the number of orphan or unavailable parent transactions (in fact, the number of parent transactions as whole) is unknown. The indegree value may instead be set as a zero value (e.g. “0”) indicating that the transaction represented by the node does not have any parent transactions that are unavailable or orphan transactions. In other words, the zero value indicates that the transaction is no longer an orphan transaction and can be released to the validation pipeline 103. Note that the zero value does not necessarily have to be the number 0, and instead could take a different form. The indegree value may instead be set as a value (e.g. a positive integer) indicating the number of parent transactions, of the transaction represented by the node, that are either unavailable transactions or orphan transactions.

Each parent node of the graph also comprises a list of references of the chid nodes that are connected to the parent node by edges. For example, if a parent node is connected to two child nodes, the list contains a respective reference to those two child nodes. The reference identifies the child node. In other words, the reference is a node identifier. The node identifier may be based on the transaction identifier of the transaction represented by the child node, e.g. a hash of the transaction identifier. In other examples, the reference may be a memory address of the child node.

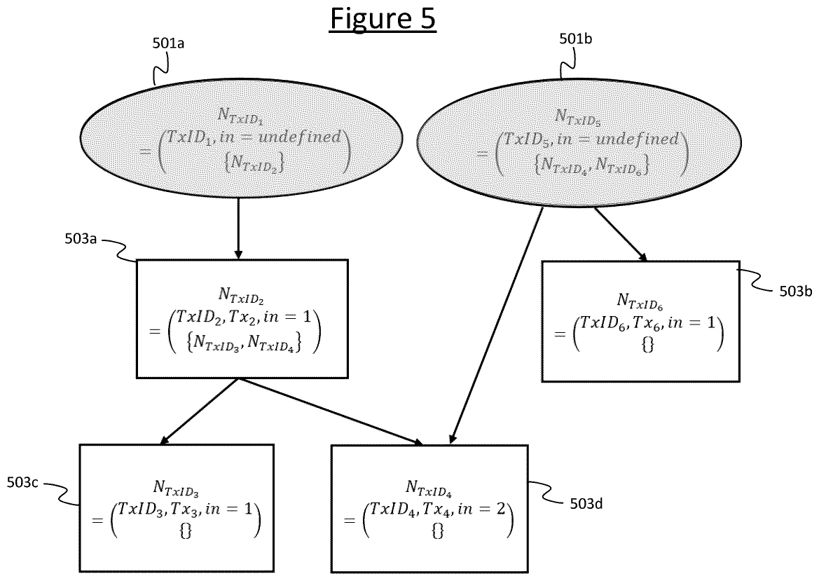

FIG. 5 illustrates an example of a graph representing an example orphan pool. The graph comprises two nodes 501a, 501b (shown shaded) representing respective unavailable transactions and four nodes 503a-d representing respective orphan transactions. The arrows are the edges that connect nodes and represent the spending of transaction outputs. In this example, each node comprises the transaction identifier TxIDᵢ of the transaction Tx₁ represented by that node. In these examples, each node is associated with a node identifier N_{TxID}_{ᵢ}, which may be used to reference the node.

As shown in FIG. 5, each node has an indegree value. The indegree value of the nodes 501a, 501b representing the unavailable transactions is set to the first value, which in this example is “undefined”. The indegree value of the nodes 503a-d representing the orphan transactions is based on the number of parent nodes. For example, node 503a has an indegree value of 1 as it has a single parent node, as does node 503b (albeit a different parent node) and node 503c (same parent node as node 503a). Node 503d has two parent nodes and therefore has an indegree value of 2.

Also shown in FIG. 5 is the list of references to the child nodes of each parent node. Node 501a references node 503a, representing the spending of an output of the parent transaction represented by node 501a by an input of the child transaction represented by node 503a. Nodes 503c, 503d do not reference any child nodes in this example.

As mentioned above, the orphan pool 401 comprises the orphan transactions. The orphan transactions are temporarily held in the orphan pool until they can be released to the validation pipeline 403. As shown in FIG. 5, the orphan transactions may be stored in the graph as part of the respective node. For instance, node N_{TxID}_{₂} comprises Tx₂. In other examples, the orphan transactions may be stored separately from the graph.

An orphan transaction may be removed from the orphan pool 403 for one or more other reasons, e.g. because the orphan transaction has been on the orphan pool for longer than a maximum allowed time limit. This helps to prevent the orphan pool from taking up too much of the blockchain node's memory.

The blockchain node 104 is configured to update the graph as more orphan transactions are obtained, e.g. received from users, such as Alice 103a and Bob 103b, or from other nodes 104. When an orphan transaction (call it a “target orphan transaction”) is received, the blockchain node 104 determines which parent transactions are missing or are themselves orphans. The blockchain node 104 executes an algorithm (referred to herein as an “add_transaction” algorithm) with the target orphan transaction as an input to update the graph. The add_transaction algorithm determines whether the target orphan transaction is represented by an existing node of the graph, e.g. a node 501a or 501b representing an unavailable transaction. For instance, the algorithm may search for the transaction identifier of the target orphan transaction. In examples where each node comprises a node identifier based on the transaction identifier, e.g. a hash of the transaction identifier, the algorithm may search for said node identifier.

If a node exists for the target orphan transaction, the node is updated, as discussed below. If a node does not exist for the target orphan transaction, the node is created and, if necessary, one or more edges are formed between the node and other nodes.

The created or updated node will be referred to as a target node. The target node is created with the necessary information, including the indegree value and the list of references to child nodes, if any. The indegree value is based on the number of parent transactions of the target orphan transaction that are missing or are themselves orphans. The orphan transaction may be included as part of the created target node. Updating the target node may comprise updating one or more edges of the graph, and/or updating the indegree value of the node.

For each parent transaction of the target node that is either an unavailable transaction or an orphan transaction, the algorithm determines whether the parent transaction is represented by a respective node. If the node is missing for the parent transaction, a parent node is created. For nodes representing unavailable transactions, the indegree value is set to the first value. A reference to the target node is added to the created parent node. If a node for the parent transaction already exists, a reference to the target node is added to the existing parent node.

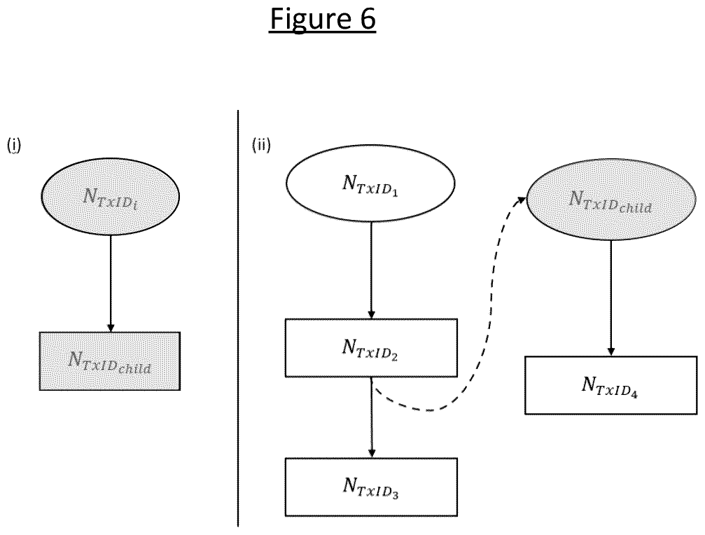

FIG. 6 illustrates an example process of adding and updating nodes representing newly obtained orphan transactions. In FIG. 6(i), a new node N_{TxID}_{_{child}} is created for orphan transaction Tx_{child}, and a new parent node N_{TxID}_{ᵢ} is created. In this example, the parent node represents an unavailable transaction. In FIG. 6(ii), a new node N_{TxID}_{_{child}} is again created for orphan transaction Tx_{child}, and this time the node N_{TxID}_{₂} which already existed is updated to reflect the relationship between Tx_{child} and Tx₂.

Turning now to the process of releasing orphan transactions to the validation pipeline 403 for validation. The blockchain node 104 obtains a transaction (call it a “first transaction”) that is either an unavailable transaction (i.e. a transaction that was an unavailable transaction until now) or an orphan transaction. The blockchain node 104 is configured to execute an algorithm (referred to herein as a “release_transaction” algorithm) with the first transaction as an input. The release transaction algorithm identifies the node in the graph representing the first transaction. The node may be identified in a similar way as described above when discussing the add_transaction algorithm determining whether a target node exists for the target node, e.g. based on the transaction identifier of the first transaction. The node representing the first transaction will be referred to as a first node. If the indegree value of the first node is set as either the first value (e.g. undefined) or the zero value (e.g. 0), then the first transaction is sent to the validation pipeline 403. The first node is removed from the graph.

The release_transaction algorithm may also be configured to, in response to being executed, update each child node of the first node. That is, the nodes representing the child transactions of the first transaction are updated, if they exist in the graph. For each child node, the release_transaction algorithm decreases the indegree value that indicates the number of parent transactions of the child transaction that are either unavailable transactions or orphan transactions. In some examples, the indegree updated value may still indicate that the child transaction has one or more such parent transactions. In other examples, the updated indegree value may be the zero value. This will be the case if the first transaction was the only parent transaction of the child transaction. The release_transaction is then executed separately for each child node of the first node. This will cause the child nodes having an updated indegree value set as the zero value to be removed from the graph and the orphan transaction represented by that child node to be released to the validation pipeline 403. The release_transaction algorithm is thus a recursive algorithm that attempts to remove any child transactions that are no longer orphans.

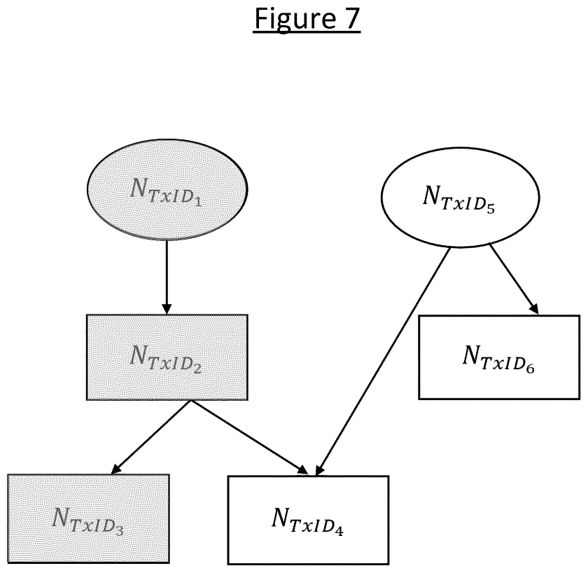

FIG. 7 illustrates an example of nodes which are removed from the graph (shown shaded), and the corresponding transactions that are released to the validation pipeline 403, in response to an unavailable transaction arriving at the blockchain node 104. In this example, nodes N_{TxID}_{₁} and N_{TxID}_{₅} represent unavailable transactions. Nodes N_{TxID}_{₂}, N_{TxID}_{₃}, N_{TxID}_{₄} and N_{TxID}_{₆} represent orphan transactions. In this example, the release_transaction has been called with Tx₁ as an input. The release_transaction identifies the child nodes of N_{TxID}_{₁} that can be removed and the corresponding transactions released to the pipeline. In this example, N_{TxID}_{₁} has one child node N_{TxID}_{₂}. The release_transaction determines that the orphan transaction corresponding to N_{TxID}_{₂} can be released to the pipeline 403, and removes node N_{TxID}_{₂} from the graph. Following on, the release_transaction identifies the child nodes of N_{TxID}_{₂} that can be removed and the corresponding transactions released to the pipeline. In this example, node N_{TxID}_{₂} has two child nodes N_{TxID}_{₃} and N_{TxID}_{₄}. The release_transaction determines that the orphan transaction corresponding to N_{TxID}_{₃} can be released to the pipeline 403, and removes node N_{TxID}_{₃} from the graph. The transaction corresponding to node N_{TxID}_{₄} cannot be released to the pipeline 403 because it has a different parent Tx₅, represented by node N_{TxID}_{₅}, which is still unavailable.

The release_transaction algorithm has similarities with a topological sorting algorithm. Nodes in the graph may be sorted level-by-level based on the indegree value, e.g. grandparent (level 0), then parent (level 1), then child (level 2), etc. Starting with the lowest level 0, the release_transaction algorithm attempts to remove the nodes at that level. The indegree values of the child nodes are updated. One or more nodes that did belong to level 1 may now belong to level 0. Again, the nodes at level 0 are removed. The indegree value of the child nodes are updated. The process repeats until no further child nodes can be removed.

The release_transaction algorithm does not go through the entire pool to un-orphan transactions, it only locates nodes with the relevant indegree value (the zero value) and then iteratively tries to un-orphan descendant transactions. The release_algorithm also only starts with only one seen (i.e. newly available) transaction that was unseen (i.e. previously unavailable). The iterative (and recursive) nature is intrinsic to the release algorithm, centralises the orphan pool management in a single entity (the pool itself). The release_transaction algorithm needs only process each orphan transaction just once.

The release_transaction algorithm may, when executed, send multiple released transactions to the validation pipeline in one go at the same time, i.e. as a batch of transactions, as opposed to one at a time.

In some embodiments, the blockchain node 104 has multiple validation pipelines 403, each configured to perform the same operations of validating transactions. That is, the node 104 may have multiple instances of a validation pipeline. As another example, the validation pipeline 403 may itself comprise multiple sub-pipelines, and/or multiple processors configured to perform the same operations. In other words, the validation pipeline 403 may be multi-threaded. The release_transaction algorithm may send one or more of the released transactions to the same pipeline 403, or to the same sub-pipeline, or to the same processor. Alternatively, the released transactions may be distributed across different pipelines 403, sub-pipelines, or processors.

A particularly advantageous option is to send a chain of transactions that have been released by the release_transaction algorithm to the same pipeline 403, sub-pipeline, or processor. This improves validation speed and reduces communication overhead since each parent transaction in the chain is used as part of the validation of the next child transaction in the chain.

As discussed, the release_transaction is executed to release orphan transactions from the orphan pool 401 and remove corresponding nodes from the graph. The release_transaction algorithm may be triggered by a listener. In these examples, each unavailable transaction is associated with a listener, e.g. when a node representing an orphan transaction is added to the graph. When the unavailable transaction enters the validation pipeline 403, the associated listener is triggered and the release_transaction algorithm is triggered with the unavailable transaction as an input. In practice, each listener is a piece of code that has visibility of transactions entering the pipeline and is configured to call other code, i.e. the release_transaction algorithm.

As another example, the blockchain node 104 may be configured to search the graph, e.g. at regular intervals, for nodes representing unavailable transactions that have been seen by the validation pipeline 403. If any such nodes exist in the graph, the release_transaction is triggered and executed with the corresponding unavailable transaction as an input.

As another example, the release_transaction algorithm may be triggered each time a transaction successfully enters (and, optionally passes through) the validation pipeline 403. If a transaction passes through the pipeline 403 it is then available for the pipeline 403 to validate its child transactions. The validation pipeline 403 communicates to the orphan pool 401 that it has seen the transaction and asks if the orphan pool 401 is waiting for the transaction. If the orphan pool is waiting for the transaction, the release_transaction algorithm is trigged.

### 5. Example Orphan Pool Implementation

This section provides details of a specific implementation of the described embodiments and shows an example of how to arrange the pool of orphaned transactions within a blockchain node 104. An unseen transaction is defined as a transaction that has not been seen by the validation pipeline 403 and contains outputs being spent by transactions in the orphan pool 401. A transaction is orphaned when one of its inputs unlocks an output of an unseen transaction. Furthermore, any transaction that unlocks an output of an orphaned transaction is also referred to as orphaned.

The orphan pool is organised by storing the spending graph of all unseen or orphaned transactions. The spending graph is a directed acyclic graph (DAG) whose nodes are unseen or orphan transactions. A directed edge from a node N₁ to N₂ represents the transaction associated with node N₂ spending an output of the transaction associated with node N₁. Each node associated to a transaction ID TxID is denoted by N_{TxID} and contains the following information (e.g. as seen in the nodes in FIG. 5):
The transaction Tx, if available.
The indegree number in defined as follows:
   undefined—the transaction itself is an unseen transaction
   0—the transaction is not orphan and can be released to the pipeline.
   any positive integer value—the number of parent transactions that are unseen or orphan.
A list of references to (e.g. memory addresses of) child nodes associated to orphan child transactions which unlock one of the outputs of the current transaction.

The orphan pool spending graph is then represented by the collection of all nodes defined as above. An example of the representation of the orphan pool is given in FIG. 5. In FIG. 5 the transaction id TxID₂ is represented by a node N_{TxID}_{₂} with references to two child nodes: N_{TxID}_{₃} and N_{TxID}_{₄}. It has one parent (in=1) because it spends some output of the unseen transaction id TxID₁, and contains the transaction Tx₂.

In the following it is assumed that that any double spend attempts are handled at the pipeline level. Consequently it is not necessary to execute any checks in the orphan pool 401 to signal double spend attempts.

An add_transaction procedure takes a transaction Tx_{child} and a list of parent transactions that are unseen or orphaned. The list of parent transaction is collected by the pipeline when trying to validate the transaction Tx_{child}. The procedure adds the transaction Tx_{child} to the spending graph. If one of the transaction inputs unlocks an output associated to an unseen transaction that is not in the orphan pool spending graph, the function listens to the pipeline for the unseen transaction.

Inputs: transaction Tx_{child}, list of k missing parent transactions TxIDᵢ for i = 1, ... , k
Execution steps:

| 1. | Compute the transaction ID TxID_{child} from the transaction Tx_{child}. | |
|---|---|---|
| 2. | If TxID_{child} exists in the spending graph data structure, retrieve the | |
| | corresponding node N_{Tx}_{_{child}} and assign the transaction Tx_{child} (e.g. Figure | |
| | 6(ii) ). To optimise retrieval, a hash map data structure H may be used that | |
| | associates a transaction ID TxID to the corresponding node. For example, | |
| | when a node N_{TxID} is created set H(TxID) = N_{TxID}. | |
| 3. | Otherwise, create a new node with the indegree value set to k (e.g. in | |
| | Figure 5 transaction TxID₄ has two parents). | |
| 4. | For each missing transaction TxIDᵢ: | |
| | a. | If a node with transaction ID TxIDᵢ does not exist in the spending |
| | | graph, create a node N_{TxID}_{ᵢ} with the indegree value set to undefined |
| | | and add the node to the spending graph (e.g. Figure 6(i) ). |
| | | Otherwise, retrieve N_{TxID}_{ᵢ}. |
| | b. | Add N_{TxID}_{_{child}} to the list of children of N_{TxID}_{ᵢ} if it's not already |
| | | added. |

A release_transactions procedure takes as input a transaction that has been seen by the pipeline. It determines which child transactions in the orphan pool can be released and sent to the pipeline. In this case, these child transactions are removed from the orphan pool and sent to the handler associated to their transaction ID for validation. In other examples, the, the TxID may determine which handler will process the transaction.

Inputs: transaction Tx
Execution steps:

| 1. | Compute transaction ID TxID from the transaction Tx. | |
|---|---|---|
| 2. | Determine the node N_{TxID} associated to the transaction ID TxID. | |
| 3. | If the indegree value of node N_{TxID} is 0, then send the transaction Tx for | |
| | validation. | |
| 4. | For each child node N_{TxID}_{_{child}} in the list of children of N_{TxID} execute: | |
| | a. | Decrease the indegree value of N_{TxID}_{_{child}} by one. |
| | b. | Call release_transactions with input Tx_{child} to try to remove any |
| | | child transactions. |

| | |
|---|---|
| 5. | If the indegree value of N_{TxID} is undefined or 0 then remove the node |
| | N_{TxID}. |

The release_transaction function may use a topological sorting algorithm, e.g. as described in Cormen, Thomas H.; Leiserson, Charles E.; Rivest, Ronald L.; Stein, Clifford (2001), Introduction to Algorithms (2nd ed.), MIT Press and McGraw-Hill, pp. 549-552, ISBN 0-262-03293-7 [Section 22.4].

The example given by FIG. 7 shows what nodes are sent for validation when the unseen transaction associated to the node N_{TxID}_{₁} enters the pipeline. The procedure release_transactions will remove the nodes N_{TxID}_{₁}, N_{TxID}_{₂} and N_{TxID}_{₃}.

An alternative to sending each transaction Tx to a handler for validation (step 4b), the procedure release_transactions can collect transactions and send them in one or more batches to handlers. When batching transactions for release, a further solution can be to send a chain of transactions (e.g. Tx₂, Tx₃) to the same StepProcessor that is validating Tx₁. Since each parent transaction in the chain is validated by the same StepProcessor, this can improve the validation speed of the transactions Tx₂ and Tx₃ by reducing communication overhead with other StepProcessors. Here, a StepProcessor is an entity in the pipeline 403 tasked with performing a particular function.

The following describes three methods which may be used to integrate the orphan pool with a blockchain node 104 in relation to how the procedure release_transactions may be called.

The first option is to add listeners for each unseen transaction. Whenever a transaction is added in the orphan pool using the procedure add_transaction, every unseen parent transaction is associated a listener. When the unseen parent transaction enters the pipeline, the listener is triggered and the procedure release_transactions is called using the unseen transaction as input.

The following method adds the listener:

```
Inputs: transaction id TxID
Execution steps:
  1. Determine the handler based on the transaction ID TxID.
  2. Adds a listener to the StepProcessor associated with the handler.
```

The implementation of this strategy should account for race conditions: for example, the parent transaction might be processed in the pipeline before step 4b.

Instead of overloading the pipeline with listeners, another option looks through the orphan pool at regular intervals (e.g. every second). If any transaction that appears as unseen in the orphan pool has been seen by the pipeline, it calls release_transactions.

The following steps are executed every time interval:
1. For every unseen transaction Tx in the orphan pool:
   a. Send a request to the pipeline to check whether the transaction Tx has been seen
   b. If the transaction Tx has been seen, call release_transactions with Tx as input

To optimise the release, the heuristic observation that “most objects die young” used in generational garbage collection techniques may be applied. In the present context this means that recently added orphan transactions have higher chances to be removed from the orphan pool. Then, to improve the responsiveness of the above steps, we can store the unseen transactions in decreasing order of the time they were added to the orphan pool. Finally, to quickly add and remove unseen transactions from the spending graph while keeping the decreasing order, a priority queue may be implemented.

Another option is to release orphan children (if any) of a transaction Tx after it has passed through a concrete StepProcessor S of the pipeline.

The following steps are executed:
1. For every transaction Tx that successfully passes through StepProcessor S:
   a. Call release_transactions with Tx as input

Each node will have their own version of the orphan pool 401, similar to memory pools 402. Orphan transactions are not propagated to other nodes in the network 106, as their validity cannot be determined. If a denial-of-service attack is attempted by overloading a node 104 with orphan transactions, only the orphan pool 401 for that node 104 will increase in size. To prevent the size from passing a certain threshold, a time limit may be imposed for each orphan transaction, after which it is deleted from the pool.

### 6. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented performed by a blockchain node and comprising:
maintaining a data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of blockchain node, and wherein:
the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and
wherein each node of the graph is associated with a respective transaction identifier of the respective transaction represented by that node and comprises:
   a) a respective indegree value, wherein the respective indegree value is one of:
      i) a first value indicating that the respective transaction has an unknown number of parent transactions that are either unavailable transactions or orphan transactions, or
      ii) a zero value indicating that the respective transaction has no parent transactions that are either unavailable transactions or orphan transactions, or
      iii) a value indicating the number of respective parent transactions of the respective transaction that are either unavailable transactions or orphan transactions; and
   b) a list of respective references of respective child nodes, if any, that are connected to that node by respective edges.

Statement 2. The method of statement 1, wherein the data structure comprises some or all of the orphan transactions.

Statement 3. The method of statement 2, wherein one, some or each node of the graph that represents a respective orphan transaction comprises the respective orphan transaction.

Statement 4. The method of statement 2 or statement 3, comprising:
removing any respective orphan transaction from the data structure in response to the respective orphan transaction having been in the data structure for a predetermined time limit.

Statement 5. The method of any preceding statement, wherein each node of the graph comprises:
c) the respective transaction identifier of the respective transaction represented by that node

Statement 6. The method of any preceding statement, comprising:
obtaining a target orphan transaction and a list of respective target parent transactions of the target transaction that are either an unavailable transaction or an orphan transaction; and
calling an add transaction algorithm with the target orphan transaction as an input, wherein calling the add transaction algorithm comprises determining whether the graph comprises a target child node representing the target orphan transaction, and based on said determining, updating the graph by creating or updating the target child node.

Statement 7. The method of statement 6, wherein said determining comprises determining whether a respective node of the graph is associated with a target transaction identifier of the target orphan transaction.

Statement 8. The method of statement 7, wherein said determining comprises generating the target transaction identifier.

Statement 9. The method of statement 6 or any statement dependent thereon, wherein calling the add transaction algorithm comprises:
for each target parent transaction in the list of respective target parent transactions of the target orphan node:
   determining whether the graph comprises a respective target parent node representing the respective target parent transaction of the target orphan transaction; and
   based on said determining, updating the graph by creating or updating the respective target parent node, wherein the respective node comprises a respective reference to the target child node.

Statement 10. The method of statement 9, wherein said creating of the respective target parent node comprises setting the respective indegree value of that respective target parent node as the first value if the respective parent transaction is an unavailable transaction.

Statement 11. The method of any preceding statement, comprising:
obtaining a first transaction and calling a release transaction algorithm with the first transaction as an input, wherein calling the release transaction algorithm comprises:
   identifying a first node of the graph that represents the first transaction; and
   if the indegree value of the first node is set as the zero value, sending the first transaction to the validation pipeline, and removing the first node from the graph.

Statement 12. The method of statement 11, wherein calling the release transaction algorithm comprises updating the graph by:
for each respective child node referenced by the first node:
   if the indegree is a positive number, updating the respective indegree value by decreasing the number of respective parent transactions that are either unavailable transactions or orphan transactions; and
   calling the release transaction algorithm with the respective child node as an input.

Statement 13. The method of statement 12, wherein calling the release transaction algorithm with the respective child nodes as input results in one or more child transactions being sent to the validation pipeline, and wherein the method comprises sending the first transaction and the one or more child transactions to the validation pipeline as a batch of transactions.

Statement 14. The method of statement 13, comprising sending the first transaction and the one or more child transactions to the same processor of the validation pipeline.

Statement 15. The method of statement 11 or any statement dependent thereon, wherein the first transaction is a respective unavailable transaction, and wherein the method comprises:
associating a respective listener with one, some, or each respective unavailable transaction; and
in response to obtaining the respective unavailable transaction, the respective listener calling the release transaction algorithm.

Statement 16. The method of statement 11 or any statement dependent thereon, comprising:
searching the data structure at regular intervals for one or more respective unavailable transactions that have become available to the validation pipeline;
identifying at least one respective unavailable transactions that has become available to the validation pipeline, wherein the first transaction is the identified respective unavailable transaction, and wherein said calling of the release transaction algorithm is in response to said identifying.

Statement 17. The method of statement 11 or any statement dependent thereon, wherein the release transaction algorithm is called in response to:
the validation pipeline informing the data structure that the first transaction has entered or exited the validation pipeline;
the data structure determining that the first transaction is represented in the data structure as an unavailable transaction.

Statement 18. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 17.

Statement 19. A computer program embodied on computer-readable storage and configured so as, when run on one or more processors, to perform the method of any of statements 1 to 17.

Statement 20. A data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of blockchain node, and wherein:
the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and
wherein each node of the graph is associated with a respective transaction identifier of the respective transaction represented by that node and comprises:
   a) a respective indegree value, wherein the respective indegree value is one of:
      i) a first value indicating that the respective transaction has an unknown number of parent transactions that are either unavailable transactions or orphan transactions, or
      ii) a zero value indicating that the respective transaction has no parent transactions that are either unavailable transactions or orphan transactions, or
      iii) a value indicating the number of respective parent transactions of the respective transaction that are either unavailable transactions or orphan transactions; and
   b) a list of respective references of respective child nodes, if any, that are connected to that node by respective edges.

1. A computer-implemented method performed by a blockchain node, the method comprising:
maintaining a data structure representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of the blockchain node, and wherein:
the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and
wherein each node of the graph is associated with a respective transaction identifier of the respective transaction represented by that node and comprises:
a) a respective indegree value, wherein the respective indegree value is one of:
(i) a first value indicating that the respective transaction has an unknown number of parent transactions that are either unavailable transactions or orphan transactions, or
(ii) a zero value indicating that the respective transaction has no parent transactions that are either unavailable transactions or orphan transactions, or
(iii) a value indicating the number of respective parent transactions of the respective transaction that are either unavailable transactions or orphan transactions; and
b) a list of respective references of respective child nodes, if any, that are connected to that node by respective edges.

2. The method of claim 1, wherein the data structure comprises some or all of the orphan transactions.

3. The method of claim 2, wherein one, some or each node of the graph that represents a respective orphan transaction comprises the respective orphan transaction.

4. The method of claim 2, further comprising removing any respective orphan transaction from the data structure in response to the respective orphan transaction having been in the data structure for a predetermined time limit.

5. The method of claim 1, wherein each node of the graph further comprises:
c) the respective transaction identifier of the respective transaction represented by that node.

6. The method of claim 1, further comprising:
obtaining a target orphan transaction and a list of respective target parent transactions of the target transaction that are either an unavailable transaction or an orphan transaction; and
calling an add transaction algorithm with the target orphan transaction as an input, wherein calling the add transaction algorithm comprises determining whether the graph comprises a target child node representing the target orphan transaction, and based on said determining, updating the graph by creating or updating the target child node.

7. The method of claim 6, wherein said determining comprises determining whether a respective node of the graph is associated with a target transaction identifier of the target orphan transaction.

8. The method of claim 7, wherein said determining comprises generating the target transaction identifier.

9. The method of claim 6, wherein calling the add transaction algorithm comprises:
for each target parent transaction in the list of respective target parent transactions of the target orphan node:
determining whether the graph comprises a respective target parent node representing the respective target parent transaction of the target orphan transaction; and
based on said determining, updating the graph by creating or updating the respective target parent node, wherein the respective node comprises a respective reference to the target child node.

10. The method of claim 9, wherein said creating of the respective target parent node comprises setting the respective indegree value of that respective target parent node as the first value if the respective parent transaction is an unavailable transaction.

11. The method of claim 1, further comprising:
obtaining a first transaction and calling a release transaction algorithm with the first transaction as an input, wherein calling the release transaction algorithm comprises:
identifying a first node of the graph that represents the first transaction; and
if the indegree value of the first node is set as the zero value, sending the first transaction to the validation pipeline, and removing the first node from the graph.

12. The method of claim 11, wherein calling the release transaction algorithm comprises updating the graph by:
for each respective child node referenced by the first node:
if the indegree is a positive number, updating the respective indegree value by decreasing the number of respective parent transactions that are either unavailable transactions or orphan transactions; and
calling the release transaction algorithm with the respective child node as an input.

13. The method of claim 12, wherein calling the release transaction algorithm with the respective child nodes as input results in one or more child transactions being sent to the validation pipeline, and wherein the method comprises sending the first transaction and the one or more child transactions to the validation pipeline as a batch of transactions.

14. The method of claim 13, comprising sending the first transaction and the one or more child transactions to the same processor of the validation pipeline.

15. The method of claim 11, wherein the first transaction is a respective unavailable transaction, and wherein the method further comprises:
associating a respective listener with one, some, or each respective unavailable transaction; and
in response to obtaining the respective unavailable transaction, the respective listener calling the release transaction algorithm.

16. The method of claim 11, further comprising:
searching the data structure at regular intervals for one or more respective unavailable transactions that have become available to the validation pipeline; and
identifying at least one respective unavailable transactions that has become available to the validation pipeline, wherein the first transaction is the identified respective unavailable transaction, and wherein said calling of the release transaction algorithm is in response to said identifying.

17. The method of claim 11, wherein the release transaction algorithm is called in response to one or both of:
the validation pipeline informing the data structure that the first transaction has entered or exited the validation pipeline; and
the data structure determining that the first transaction is represented in the data structure as an unavailable transaction.

18. (canceled)

19. A computer program embodied on non-transitory computer-readable storage media and configured so as, when run on one or more processors, the one or more processors perform a method comprising:
maintaining a data structure representing orphan transactions, wherein:
an orphan transaction is a blockchain transaction having at least one parent transaction that is one of an unavailable transaction and a different orphan transaction;
an unavailable transaction is a transaction that is not available to a validation pipeline of a blockchain node;
the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and
each node of the graph is associated with a respective transaction identifier of the respective transaction represented by that node and comprises:
a) a respective indegree value that is one of:
(i) a first value indicating that the respective transaction has an unknown number of parent transactions that are either unavailable transactions or orphan transactions;
(ii) a zero value indicating that the respective transaction has no parent transactions that are either unavailable transactions or orphan transactions; and
(iii) a value indicating the number of respective parent transactions of the respective transaction that are either unavailable transactions or orphan transactions; and
b) a list of respective references of respective child nodes, if any, that are connected to that node by respective edges.

20. A data structure embodied on non-transitory computer readable media and representing orphan transactions, wherein an orphan transaction is a blockchain transaction having at least one parent transaction that is an unavailable transaction and/or at least one parent transaction that is a different orphan transaction, wherein an unavailable transaction is a transaction that is not available to a validation pipeline of a blockchain node, and wherein:
the data structure comprises a directed graph of nodes and edges, wherein each node of the graph represents either a respective orphan transaction or a respective unavailable transaction, wherein each edge connecting a respective parent node to a respective child node represents the spending of an output of the respective transaction represented by the respective parent node by an input of the respective transaction represented by the respective child node; and
wherein each node of the graph is associated with a respective transaction identifier of the respective transaction represented by that node and comprises:
a) a respective indegree value, wherein the respective indegree value is one of:
i) a first value indicating that the respective transaction has an unknown number of parent transactions that are either unavailable transactions or orphan transactions, or
ii) a zero value indicating that the respective transaction has no parent transactions that are either unavailable transactions or orphan transactions, or
iii) a value indicating the number of respective parent transactions of the respective transaction that are either unavailable transactions or orphan transactions; and
b) a list of respective references of respective child nodes, if any, that are connected to that node by respective edges.
